(19) United States
(12) Patent Application Publication
(10) Pub. No.: US 2025/0100716 A1
(43) Pub. Date: Mar. 27, 2025

(54) Suspended Phased Oscillators for Attitude Control

(71) Applicant: The Board of Trustees of the University of Illinois, Urbana, IL (US)

(72) Inventor: . Vedant, Urbana, IL (US)

(21) Appl. No.: 18/832,007

(22) PCT Filed: Jan. 26, 2023
(86) PCT No.: PCT/US2023/061380

§ 371 Date: Jul. 22, 2024

Related U.S. Application Data
(60) Provisional application No. 63/306,793, filed on Feb. 4, 2022.

(51) Int. Cl. B64G 1/36; B64C 17/02; B64G 1/32

(52) U.S. Cl. CPC B64G 1/369; B64C 17/02; B64G 1/32

(57) ABSTRACT

A system may include an object having a rotational axis. The system may also include a first mass movably mounted to the object and configured to adjust a moment of inertia of the object by translating relative to the object along an inertial path having a first component that is perpendicular to the rotational axis. The system may additionally include a second mass movably mounted to the object and configured to: apply to the object a first torque in a first direction along the rotational axis while the moment of inertia is adjusted above a threshold value and apply to the object a second torque in a second direction along the rotational axis while the moment of inertia is adjusted below the threshold value, by translating relative to the object along a torque path having a second component that is perpendicular to the rotational axis and the first component.

### CROSS-REFERENCE TO RELATED APPLICATIONS

This application claims priority to U.S. Provisional Patent Application No. 63/306,793, filed on Feb. 4, 2022, and titled “Suspended Phased Oscillators for Attitude Control,” which is hereby incorporated by reference as if fully set forth in this description.

### BACKGROUND

Attitude control systems are used to orient a spacecraft to a particular point in the sky, or to maintain a specific orientation over time. Accuracy of attitude control may be critical, especially for certain type of payloads (e.g., optics-based payloads). Existing control systems, such as reaction wheel assemblies (RWA), control moment gyroscopes (CMG), reaction thrusters, and magnetic torque coils all have various disadvantages. RWAs and CMGs require constant rotation, which can decrease reliability and cause jitters and vibrations transmitted to the rest of the spacecraft. Furthermore, RWAs and CMGs can become saturated, causing a lack of attitude control about one or more axes. Reaction thrusters require fuel to operate, increasing the weight of the spacecraft.

### SUMMARY

An attitude control system of an object that can reduce excess vibrations, increase reliability, and/or operate without fuel is desirable. Such an attitude control system may include at least two masses that are configured to cause the object to rotate about at least one rotational axis thereof. A first mass may be moved relative to a center of mass of the object to adjust a moment of inertia of the object about the rotational axis, and may thus be referred to as an inertial mass. A second mass may be moved relative to the object to apply a torque to the object about the rotational axis, and may thus be referred to as a torque mass.

While the inertial mass is positioned to increase the moment of inertia to a relatively high value (e.g., above a threshold), the torque mass may be actuated to apply a torque in a first direction, resulting in a first angular displacement in the first direction. While the inertial mass is positioned to decrease the moment of inertia to a relatively low value (e.g., below the threshold), the torque mass may be actuated to apply a torque in a second direction opposite to the first direction, resulting in a second angular displacement in the second direction. Both the torque in the first direction and the torque in the second direction may be applied for the same time duration. Thus, the second angular displacement may be greater than the first angular displacement, resulting in a net rotation of the object in the second direction. This process may be repeated, and/or the relative phase of movements of the inertial mass and torque mass may be modified, to achieve a desired rotation of the object about the rotational axis.

The masses may be mounted to the object by way of corresponding actuators. Each actuator may include a corresponding channel, tunnel, and/or conduit within which a mass is configured to move. The actuators may be configured to actuate the masses by applying thereto an electric field (e.g., the masses may hold a static charge) and/or magnetic fields (e.g., the masses may exhibit permanent and/or induced magnetism). Thus, the masses may operate in a contactless manner. That is, adjustment of the moment of inertia of the object and/or application of a torque to the object might not depend on a mechanical connection between the masses and the object, thereby reducing the number of potential mechanical failure points of the attitude control system.

Accordingly, a first example embodiment may involve an object that includes a rotational axis. The first example embodiment may also include a first mass movably mounted to the object and configured to adjust a moment of inertia of the object by translating relative to the object along an inertial path having a first component that is perpendicular to the rotational axis. The first example embodiment may further include a second mass movably mounted to the object and configured to: (i) apply to the object a first torque in a first direction along the rotational axis while the moment of inertia is adjusted above a threshold value and (ii) apply to the object a second torque in a second direction along the rotational axis while the moment of inertia is adjusted below the threshold value, by translating relative to the object along a torque path having a second component that is perpendicular to the rotational axis and the first component.

A second example embodiment may involve adjusting a moment of inertia of an object by translating a first mass relative to the object and along an inertial path. The first mass may be movably mounted to the object, and the inertial path may include a first component that is perpendicular to a rotational axis of the object. The second example embodiment may also involve applying to the object a first torque in a first direction along the rotational axis while the moment of inertia is adjusted above a threshold value by translating a second mass relative to the object and along a torque path. The second mass may be movably mounted to the object, and the torque path may include a second component that is perpendicular to the rotational axis and the first component. The second example embodiment may further involve applying to the object a second torque in a second direction along the rotational axis while the moment of inertia is adjusted below the threshold value by translating the second mass relative to the object and along the torque path.

In a third example embodiment, a non-transitory computer-readable medium may have stored thereon program instructions that, upon execution by a computing system, cause the computing system to assist with operation of the first and/or second example embodiment.

In a fourth example embodiment, a computing system may include at least one processor, as well as memory and program instructions. The program instructions may be stored in the memory, and upon execution by the at least one processor, cause the computing system to assist with operation of the first and/or second example embodiment.

In a fifth example embodiment, a system may include an object that includes a rotational axis. The system may also include a first means for adjusting a moment of inertia of the object by translating a first mass relative to the object and along an inertial path having a first component that is perpendicular to the rotational axis. The first mass may be movably mounted to the object. The system may additionally include a second means for: (i) applying to the object a first torque in a first direction along the rotational axis while the moment of inertia is adjusted above a threshold value and (ii) applying to the object a second torque in a second direction along the rotational axis while the moment of inertia is adjusted below the threshold value, by translating a second mass relative to the object along a torque path having a second component that is perpendicular to the rotational axis and the first component. The second mass may be movably mounted to the object.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIGS. 1A, 1B, and 1C illustrate side views of a body and an elongated member in different positions, in accordance with example embodiments.

FIG. 2 illustrates an inertial mass and a torque mass movably mounted on an object, in accordance with example embodiments.

FIG. 3 illustrates rotation of an object caused by movement of the inertial mass and the torque mass, in accordance with example embodiments.

FIGS. 4A and 4B illustrate control strategies for the inertial mass and the torque mass, in accordance with example embodiments.

FIG. 5 illustrates an arrangement with multiple inertial masses and multiple torque masses, in accordance with example embodiments.

FIG. 6 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Example Strain-Based Attitude Control Systems

An Attitude Control System (ACS) is a sub-system of a spacecraft that may be important for proper functioning and positioning of the spacecraft. For example, several mission classes, such space observatories, synthetic-aperture radar (SAR), and/or deep space missions, among others, may rely on a precise, accurate, and/or reliable ACS. Some commonly used ACSs for large-angle slewing include Reaction Wheel Assemblies (RWAs) and Control Moment Gyroscopes (CMGs). Other ACSs may utilize existing deployable structures/appendages (such as solar arrays or radiators) to perform attitude control. For example, transverse oscillations of the deployable panels may be utilized in combination with moment of inertia (MOI) reconfigurations to produce a change in attitude of the spacecraft. One mechanism for changing MOI is to induce longitudinal strains, thereby increasing or decreasing the MOI about the vehicle axis of rotation.

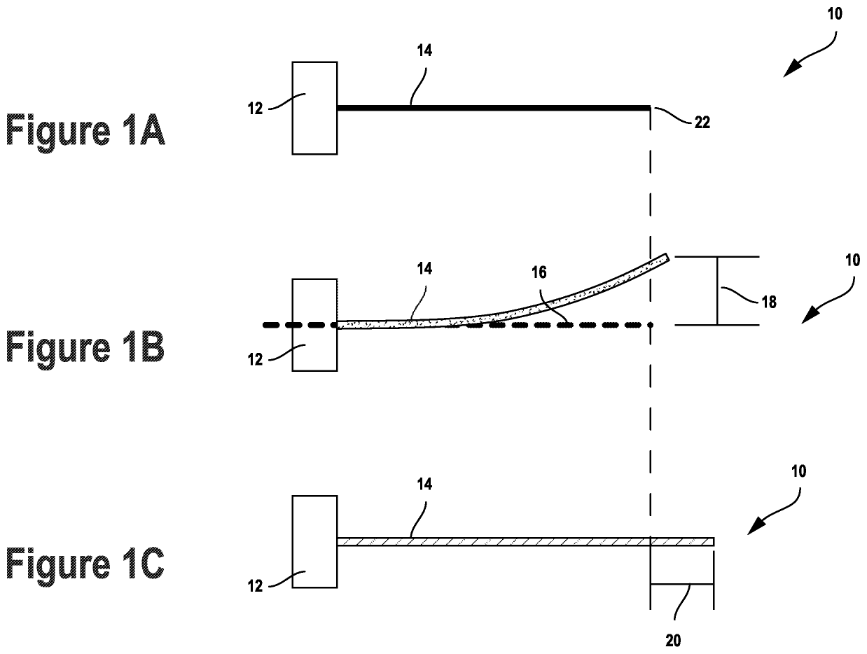

FIGS. 1A, 1B, and 1C illustrate one possible instantiation of a strain-based ACS. Specifically, FIGS. 1A, 1B, and 1C illustrate side views of spacecraft 10 having body 12 and elongated member 14. Each of FIGS. 1A, 1B, and 1C illustrates elongated member 14 in a different position. Spacecraft 10 may be any vehicle adapted to travel through space, such as a satellite, rocket, and/or space station. Body 12 may be any portion of spacecraft 10 which may carry a payload and/or about which spacecraft 10 may be rotated. Examples of body 12 may include a housing, a fuselage, a sensor, and/or a telescope. Elongated member 14 may be a portion of spacecraft 10 which is coupled to and/or extends away from body 12 to allow attitude adjustment of spacecraft 10. Examples of elongated member 14 may include a pylon, a solar panel, and/or a truss.

Elongated member 14 may extend away from body 12 along axis 16 shown in FIG. 1B. Axis 16 may be any line which passes through body 12 and along which elongated member 14 may be aligned. In some embodiments, axis 16 may be defined as the midpoint between the full range of deflection of elongated member 14. In some embodiments, axis 16 may pass through the center of mass of spacecraft 10.

As shown in FIG. 1A, before movement of elongated member 14, elongated member 14 may have an initial angular position with respect to the axis 16 and an initial length 22. As illustrated in FIG. 1B, a position of elongated member 14 may be deflected (e.g., deflection 18) and/or rotated relative to axis 16 to produce a corresponding angular rotation of spacecraft 10. Additionally, as shown in FIG. 1C, initial length 22 of elongated member 14 may be compressed or extended (e.g., extension 20) to change the mass moment of inertia of elongated member 14. Extending elongated member 14 may increase the mass moment of inertia, while compressing elongated member 14 may decrease the mass moment of inertia.

Within examples, the mass moment of inertia of an object and/or parts thereof may be represented as a nine-element mass moment of inertia tensor that quantifies rotational inertial dynamics for the object and/or parts thereof. The moment of inertia tensor may be defined with respect to a coordinate system. In some embodiments, the moment of inertia tensor may be defined with respect to a body-fixed coordinate system at a center of mass of the object. In the single axis rotational motions described in the examples provided herein, a change to the moment of inertia may correspond to changing a single element of the moment of inertia tensor. It is to be understood, however, that multiple elements of the moment of inertia tensor may be changed by using the techniques discussed herein. Changes of multiple elements of the moment of inertia tensor may enable more complex behavior that may be tailored for particular systems and/or maneuvers. For example, a cross-term of the moment of inertia tensor may be adjusted such that an overall object rotation may be produced about multiple axes in desired ways.

The angular deflections, extensions, and compressions of the elongated member may be accomplished by multiple actuators coupled to elongated member 14. These actuators may be any combination of devices which are capable of deflecting the angular position of elongated member 14 and/or altering the mass moment of inertia of elongated member 14 by extension and/or compression. Examples of such actuators may include a rotational joint, an array of piezoelectric actuation elements, a lever mechanism, and/or a linear prismatic joint, among other possibilities.

Spacecraft 10 may be rotated by, for example, compressing elongated member 14 to a first length, which may reduce the moment of inertia of spacecraft 10. While elongated member 14 is compressed to the first length, elongated member 14 may be deflected in a first direction (e.g., up, as shown in FIG. 1B) by a predetermined angle, which may apply a first torque to spacecraft 10. Elongated member 14 may then be extended to a second length (e.g., as shown in FIG. 1C), which may increase the moment of inertia of spacecraft 10. While elongated member 14 is extended to the second length, elongated member 14 may be deflected in a second direction (e.g., down) by the predetermined angle, which may apply to spacecraft 10 a second torque that is opposite to the first torque.

Due to the difference in the moment of inertia, the predetermined angle may be traversed faster in the first direction than in the second direction. Accordingly, the second toque may cause a second angular impulse (i.e., product of the second torque and the time taken to traverse the predetermined angle in the second direction) that exceeds a first angular impulse (i.e., product of the first torque and the time taken to traverse the predetermined angle in the first direction) applied by the first torque, thereby causing a net rotation of spacecraft 10 in the direction of the second torque.

Repeated compression, extension, and/or deflection of elongated member 14 may, however, cause elongated member 14 to experience a failure at one or more portions thereof. A likelihood of failure of elongated member 14 may be reduced by using stronger materials and/or otherwise reinforcing portions of elongated member 14 that experience significant stresses, which may increase the cost of making spacecraft 10. Additionally, in some cases, it may be difficult to integrate into elongated member 14 the actuators involved in producing the above-described motions, especially when elongated member 14 is configured to provide other functions to spacecraft 10 (e.g., operate as a solar panel). Further, when elongated member 14 is relatively large in relation to spacecraft 10 as a whole, it may be difficult to achieve a sufficiently fast response time of the compression, extension, and/or deflection to allow elongated member 14 to counteract some high-frequency vibrations of spacecraft 10.

### II. Example Suspended Oscillating Mass-Based Attitude Control Systems

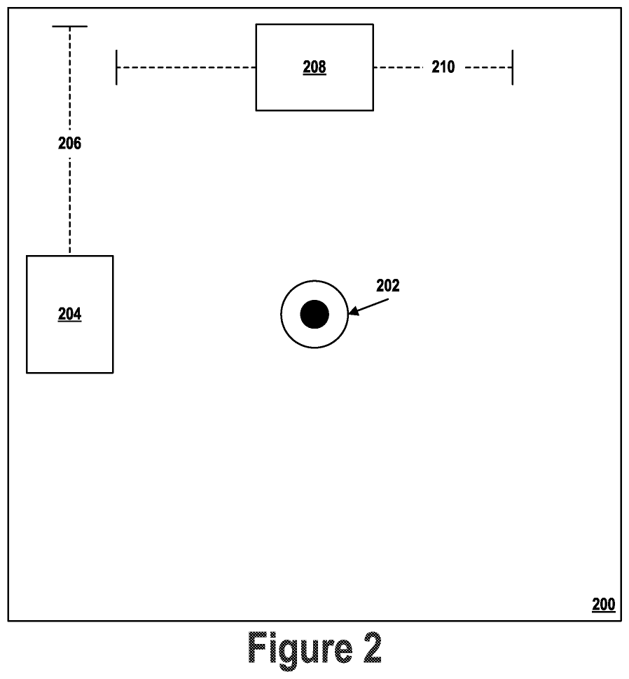

FIG. 2 illustrates an example arrangement of an attitude control system that utilizes moving masses to control an attitude of an object. The arrangement of FIG. 2 may mitigate at least some of the drawbacks of the strain-based ACS illustrated in FIGS. 1A, 1B, and 1C. Specifically, object 200 may include rotational axis 202 coming out of the page, inertial mass 204, and torque mass 208. Object 200 may represent, for example, a spacecraft (e.g., spacecraft 10), an aircraft, a suspended platform, and/or another system where attitude control and/or vibration control is desirable. While FIG. 2 shows that a cross-section of object 200 is, for the purpose of a simplified example, a square, object 200 may, in general, have various other regular and/or irregular cross-sections.

Masses 204 and/or 208 may be shaped as rectangular prisms, cylindrical prisms, and/or spheres, among other possibilities. Inertial mass 204 and torque mass 208 may each be movably mounted to object 200 by way of a corresponding actuator configured to cause the respective mass to move relative to object 200. Inertial mass 204 and/or torque mass 208 may be mounted inside of object 200, on the outside of object 200, and/or in or on one or more appendages of object 200. That is, the placement of masses 204 and/or 208 may be varied, provided that the masses are capable of performing the operations herein described.

Inertial mass 204 may be qualified as “inertial” in that it may be used primarily to adjust a moment of inertia of object 200, while torque mass 208 may be qualified as “torque” in that it may be used primarily to apply a torque to object 200. Inertial mass 204 and torque mass 208 may alternately be referred to as first mass 204 and second mass 208, respectively.

Inertial mass 204 may be configured to move along an inertial path. Inertial axis 206 provides a linear example of the inertial path. Inertial axis 206 is shown as being substantially perpendicular to rotational axis 202. Torque mass 208 may be configured to move along a torque path. Torque axis 210 provides a linear example of the torque path. Torque axis 210 is shown as being substantially perpendicular to rotational axis 202 and inertial axis 206. A first axis may be considered substantially perpendicular to a second axis when the two are within 0-10 degrees of exactly perpendicular, thus allowing for a deviation from exact perpendicularity due to, for example, manufacturing and/or assembly variations. It is to be understood that, in other implementations, the inertial path and/or the torque path may be and/or may include nonlinear portions. For example, the inertial path and/or the torque path may include an arc. The arc may be circular or elliptical, and may be centered on rotational axis 202, for example.

In some embodiments, the inertial path (e.g., inertial axis 206, an inertial arc) might not be substantially perpendicular to rotational axis 202, provided that a first component of the inertial path is perpendicular to rotational axis 202. Similarly, the torque path (e.g., torque axis 210, a torque arc) might not be substantially perpendicular to rotational axis 202 and/or inertial axis 206, provided that a second component of the torque path is perpendicular to rotational axis 202 and the first component of inertial axis 206. In such cases, motion of inertial mass 204 along at least the first component may be used to adjust the moment of inertia of object 200, and motion of torque mass 208 along at least the second component may be used to apply torque to object 200. A given path may be divided into one or more components by, for example, determining one or more vector components of a vector that describes one or more properties (e.g., force, acceleration, velocity, displacement) of a motion of the mass along the given path. The one or more vector components may be determined with respect to a reference coordinate frame that may be, for example, centered on a center of mass of object 200 and oriented to align at least one coordinate axis thereof with rotational axis 202.

Inertial mass 204 may be actuated along inertial axis 206 by a first actuator, and torque mass 208 may be actuated along torque axis 210 by a second actuator. For example, the corresponding actuator of each respective mass of masses 204 and 208 may include a corresponding channel, tunnel, and/or conduit that extends along at least the corresponding motion axis for the respective mass. Thus, the corresponding tube or channel may have a longitudinal axis that is parallel to or coincident with the corresponding motion axis for the respective mass. A cross-section of the channel, tunnel, and/or conduit along a plane that is normal to the longitudinal axis may be larger than, and may match a corresponding cross-section of, the respective mass, thereby allowing the respective mass to move through the corresponding channel, tunnel, and/or conduit.

The actuator may be configured to apply forces to the corresponding mass by generating an electric field and/or a magnetic field. The electric and/or magnetic field may extend through the channel, tunnel, and/or conduit, and interact with the mass therein to apply a force to the mass. The direction and strength of the electric and/or magnetic field may be varied over time to achieve a desired motion profile for the mass.

In some embodiments, the actuator may generate a first magnetic field, at least a portion of which is directed parallel to the longitudinal axis of and/or central path through the channel, tunnel, and/or conduit, and is configured to apply a force to the corresponding mass by interacting with a second magnetic field of the mass. For example, the actuator may operate as a solenoid, while the mass may be and/or may include a permanent magnet, a ferromagnetic material, and/or a conductor capable of sustaining an eddy current induced therein by the actuator. In another example, the actuator may operate as a linear induction motor, with a winding on the channel, tunnel, and/or conduit operating as a primary (e.g., linear-equivalent of a stator) and the mass operating as a secondary (e.g., linear-equivalent of a rotor).

In other embodiments, the actuator may generate an electric field, at least a portion of which is directed parallel to the longitudinal axis of and/or central path through the channel, tunnel, and/or conduit, and is configured to apply a force to the corresponding mass by interacting with an electrostatic charge held by the mass. For example, the electric field may be generated between a first conductive plate at a first end of the channel, tunnel, and/or conduit and a second conductive plate at a second end of the channel, tunnel, and/or conduit. The mass may be electrically isolated from each of the first conductive plate and the second conductive plate by dielectric membranes that prevent the mass from discharging the electrostatic charge to either conductive plate.

In some cases, such as in applications that involve a substantially gravity-free environment, the respective mass may operate in a substantially contactless manner. For example, the respective mass might not be mechanically connected to the channel, tunnel, and/or conduit within which it is configured to move, and may be controlled with the electric and/or magnetic field(s) which do not depend on physical contact with the respective mass to exert a force thereon. Thus, an ACS based on masses 204 and 208 may, due to the contactless manner of operation, have a reduced number of potential mechanical failure points.

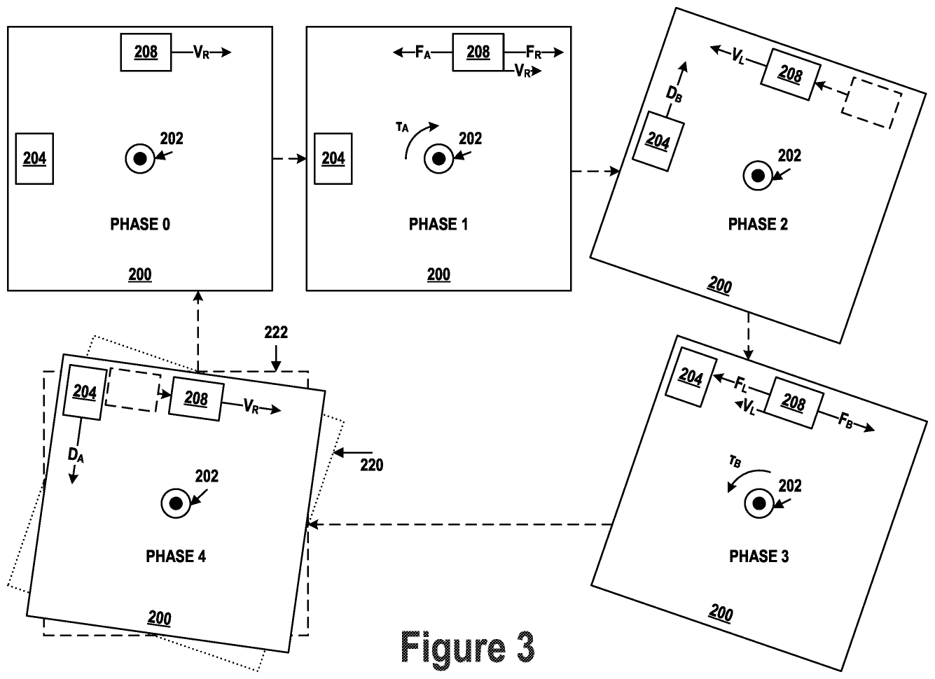

FIG. 3 illustrates example coordinated movements of masses 204 and 208 to produce a rotation of object 200 around rotational axis 202. Specifically, object 200 may start in the orientation designated as phase 0, with inertial mass 204 located at a bottom end of inertial axis 206 (i.e., along a horizontal centerline of object 200), and torque mass 208 moving (i.e., translating) right relative to object 200 at a constant velocity V_{R} and with no forces being applied thereto. As a result of the positioning of inertial mass 204 shown in phase 0, the moment of inertia of object 200 may have a first value I_{A}.

Between phase 0 and phase 1, the actuator of torque mass 208 may start applying to torque mass 208 a force directed left in order to reverse a direction of movement (i.e., translation) of torque mass 208 relative to object 200. Thus, in phase 1, torque mass 208 may experience a force F_{A} directed left, which may cause an equal and opposite reaction force F_{R} to be applied to object 200. Due to the force applied to torque mass 208 by its actuator, the velocity V_{R} may decrease, as indicated by the shortened velocity vector V_{R} in phase 1 relative to phase 0. Reaction force F_{R} may apply a torque τ_{A} to object 200, which may be represented by a torque vector directed into the page along rotational axis 202 and which may tend to cause object 200 to rotate clockwise, as shown by the arcuate arrow in phase 1.

Application of torque τ_{A} to object 200 may cause object 200 to rotate clockwise, as indicated by the change in orientation of object 200 from phase 1 to phase 2. Between phase 1 and phase 2, the actuator of torque mass 208 may continue applying to torque mass 208 a force directed left, resulting in torque mass 208 reaching zero velocity at a rightmost end of torque axis 210 (as indicated by the dashed outline), and then moving (i.e., translating) left relative to object 200 at a constant velocity V_{L} and with no forces being applied thereto, as shown in phase 2. While torque mass 208 is moving (i.e., translating) left at the constant velocity V_{L}, inertial mass 204 may be moved from its position at the bottom end of inertial axis 206 to a position at a top end of inertial axis 206, as indicated by displacement vector D_{B}. As a result of the positioning of inertial mass 204 shown in phase 2, the moment of inertia of object 200 may have a second value I_{B} that is greater than the first value I_{A} due to inertial mass 204 being farther away from a center of mass of object 200.

Between phase 2 and phase 3, the actuator of torque mass 208 may start applying to torque mass 208 a force directed right in order to reverse a direction of motion of torque mass 208. Thus, in phase 3, torque mass 208 may experience a force F_{B} directed right, which may cause an equal and opposite reaction force F_{L} to be applied to object 200. Due to the force applied to torque mass 208 by its actuator, the velocity V_{L} may decrease, as indicated by the shortened velocity vector V_{L} in phase 3 relative to phase 2. Reaction force F_{L} may apply a torque τ_{B} to object 200, which may be represented by a torque vector directed out of the page along rotational axis 202 and which may tend to cause object 200 to rotate counterclockwise, as shown by the arcuate arrow in phase 3.

Application of torque τ_{A} to object 200 may cause object 200 to rotate clockwise, as indicated by the change in orientation of object 200 from phase 3 to phase 4. Reaction force F_{L} may be equal and opposite to reaction force F_{R}, and thus torque τ_{B} may be equal and opposite to torque τ_{A}. Reaction forces F_{L} and F_{R} may be applied for the same amount of time t. Thus, since the moment of inertia I_{B} in phase 3 is greater than the moment of inertia I_{A} in phase 1, torque τ_{B} causes object 200 to rotate through a smaller angle than torque τ_{A} (i.e., θ_{A}>θ_{B}). Specifically, due to balancing of torques and/or conservation of angular momentum, τ_{A}=I_{A}α_{A}=I_{B}α_{B}=τ_{B}, thus I_{A}(ω_{A}/t)=I_{B}(ω_{B}/t), thus I_{A}ω_{A}=I_{B}ω_{B}, thus I_{A}(θ_{A}/t)=I_{B}(θ_{B}/t) and thus I_{A}θ_{A}=I_{B}θ_{B} and I_{A}/I_{B}=θ_{B}/θ_{A}, where α_{A}, ω_{A}, and θ_{A} represent the angular acceleration, angular velocity, and angular displacement, respectively, caused by torque τ_{A}, and α_{B}, ω_{B}, and θ_{B} represent the angular acceleration, angular velocity, and angular displacement, respectively, caused by torque τ_{B}.

Accordingly, the counterclockwise rotation θ_{B} from phase 3 to phase 4 may have a smaller magnitude than the clockwise rotation θ₄ from phase 1 to phase 2, resulting in a net clockwise rotation of object 200. The orientation of object 200 in phase 3 is shown relative to the orientation in phase 4 using dashed outline 220. The original orientation of object 200 in phase 0 is shown relative to the orientation in phase 4 using dashed outline 222, indicating the net clockwise rotation of object 200. Masses 204 and 208 may be returned to the configuration shown in phase 0, and the transitions through phases 0-4 may be repeated to produce further net clockwise rotations. A net counterclockwise rotation may be achieved by, for example, advancing or retarding a timing of torque mass 208 relative to a timing of inertial mass 204 by one half of an oscillation period, thus causing a (larger) counterclockwise rotation while the moment of inertia is at I_{A} and a (smaller) clockwise rotation while the moment of inertia is at I_{B}.

Between phase 3 and phase 4, the actuator of torque mass 208 may continue applying to torque mass 208 a force directed right, resulting in torque mass 208 reaching zero velocity at a leftmost end of torque axis 210 (as indicated by the dashed outline) in phase 4 and then moving (i.e., translating) right relative to object 200 at a constant velocity V_{R} and with no forces being applied thereto, as shown in phase 4. While torque mass 208 is moving (i.e., translating) right at the constant velocity V_{R}, inertial mass 204 may be moved from its position at the top end of inertial axis 206 to a position at the bottom end of inertial axis 206, as indicated by displacement vector D_{A}. Thus, masses 204 and 208 may return to the configuration of phase 0, while object 200 retains the net clockwise rotation shown in phase 4.

### III. Example Motion Control Profiles

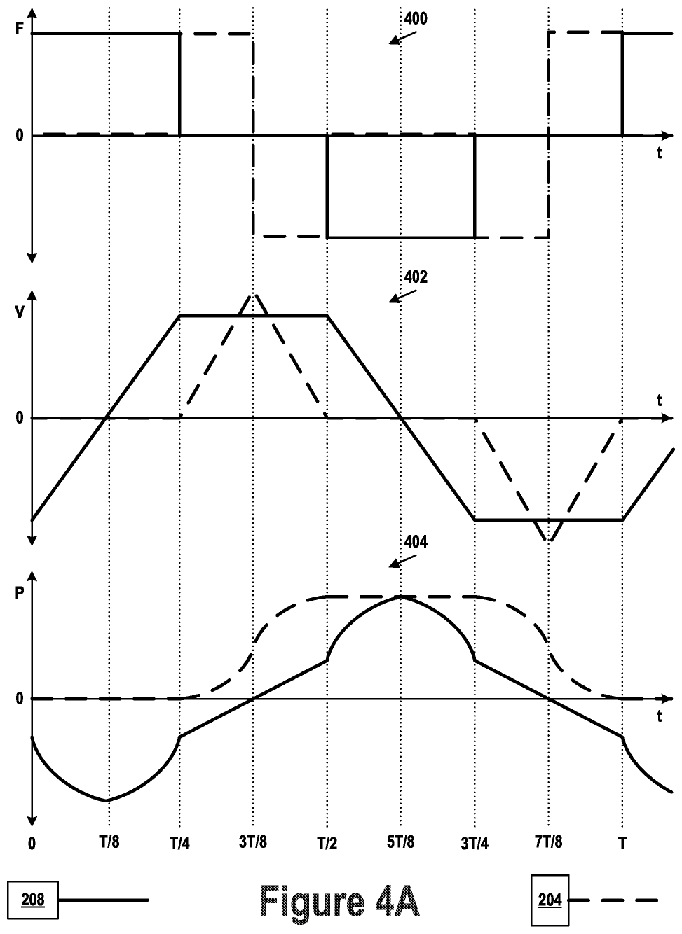

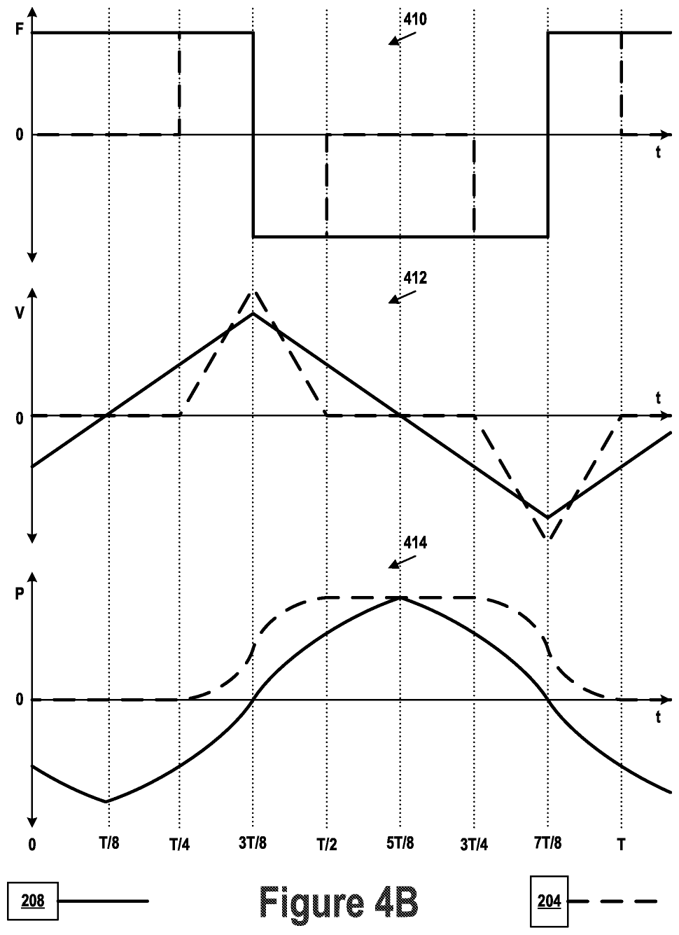

FIGS. 4A and 4B illustrate two example control strategies for using masses 204 and 208 to generate a net rotation of object 200 around rotational axis 202. FIG. 4A includes plot 400 of respective forces applied to masses 204 and 208 over time, plot 402 of respective velocities of masses 204 and 208 over time, and plot 404 of respective positions of masses 204 and 208 over time. FIG. 4B includes commensurate plots 410, 412, and 414. For inertial mass 204, position zero represents a bottom of inertial axis 206 (e.g., a location along a midline running horizontally through object 200). For torque mass 208, position zero represents a middle of torque axis 210 (e.g., a location along a midline running vertically through object 200). Properties of torque mass 208 are graphed using a solid line, while properties of inertial mass 204 are graphed using a dashed line, each of which may be graphed relative to its own vertical axis scale (i.e., the same vertical point on the solid line and on the dashed line does not necessarily represent the same value). The plots of FIGS. 4A and 4B represent one oscillation period T, which may be repeated multiple time to achieve a desired rotation of object 200. Thus, both the solid line and the dashed line utilize a shared horizontal axis scale.

FIG. 4A provides a graphical representation of a first example control strategy, which may be similar to that shown in and discussed with respect to FIG. 3. Specifically, from t=0 to t=T/4, inertial mass 204 may be at a first end (e.g., bottom end) of inertial axis 206, and torque mass 208 may initially be moving with a negative velocity (e.g., leftward). Thus, the moment of inertia of object 200 may be below a threshold value (e.g., I_{A}+I_{B}−I_{A}/2). For example, the moment of inertia may have value I_{A}.

A positive (e.g., rightward) force may be applied to torque mass 208, thus causing torque mass 208 to change its direction of movement (e.g., change from moving left to moving right) and reach a first end (e.g., the left end) of torque axis 210 at t=T/8. The positive force applied to torque mass 208 may exert on object 200 a corresponding negative force of the same magnitude, thus causing object 200 to rotate in the negative direction (e.g., counterclockwise) by a first angular displacement (e.g., θ_{C}).

At t=T/4, torque mass 208 may reach a positive velocity that may be maintained until t=T/2. While torque mass 208 moves at this constant positive velocity, and forces are thus not exerted thereby on object 200, inertial mass 204 may be moved from the first end of inertial axis 206 to a second end (e.g., top end) of inertial axis 206. Thus, the moment of inertia of object 200 may be above the threshold value. For example, the moment of inertia may have value I_{B}.

From t=T/2 to t=3T/4, inertial mass 204 may remain at the second end of inertial axis 206, and a negative force may be applied to torque mass 208, thus causing torque mass 208 to again change its direction of movement (e.g., change from moving right to moving left) and reach a second end (e.g., the right end) of torque axis 210 at t=5T/8. The negative force applied to torque mass 208 may exert on object 200 a corresponding positive force of the same magnitude, thus causing object 200 to rotate in the positive direction (e.g., clockwise) by a second angular displacement (e.g., θ_{D}) that is smaller than the first angular displacement (e.g., due to I_{B}>I_{A}), resulting in a net negative (e.g., counterclockwise) rotation of object 200 having magnitude |θ_{C}|−|θ_{D}|.

At t=3T/4, torque mass 208 may reach a negative velocity that may be maintained until t=T. While torque mass 208 moves at this constant negative velocity, and forces are thus not exerted thereby on object 200, inertial mass 204 may be moved from the second end of inertial axis 206 back to the first end of inertial axis 206. Thus, the moment of inertia of object 200 may again be below the threshold value For example, the moment of inertia may again have value I_{A}. The trajectories masses 204 and 208 may be repeated to produce further net negative (e.g., counterclockwise) rotation of object 200. The trajectory of torque mass 208 may be inverted, or shifted in time by T/2, to instead produce a net positive (e.g., clockwise) rotation of object 200.

FIG. 4B provides a graphical representation of a second example control strategy. The first example control strategy shown in FIG. 4A includes time periods during which a force is not applied to torque mass 208, resulting in torque mass 208 coasting at a constant speed, and thus allowing for the moment of inertia to be adjusted while torque is not being applied by torque mass 208. The second example control strategy shown in FIG. 4B does not include time periods during which torque mass 208 is allowed to coast, and instead alternates a direction in which torque mass 208 is accelerated. Inertial mass 204 is controlled in the same manner in both the control strategy of FIG. 4A and FIG. 4B. The second example control strategy may be used, for example, when the actuators of masses 204 and/or 208 are unable to generate sufficiently high forces to allow mass 208 to coast during an oscillation period having a desired length.

Specifically, from t=0 to t=3T/8, a positive force may be applied to torque mass 208, thus causing torque mass 208 to accelerate in the positive direction and change its direction of movement (e.g., change from moving left to moving right). Torque mass 208 may reach a first end (e.g., the left end) of torque axis 210 at t=T/8, and may reach a maximum positive speed at t=3T/8. The positive force applied to torque mass 208 may exert on object 200 a corresponding negative force of the same magnitude, thus causing object 200 to rotate in the negative direction (e.g., counterclockwise by angular displacement θ_{E}).

From t=3T/8 to t=7T/8, a negative force may be applied to torque mass 208, thus causing torque mass 208 to accelerate in the negative direction and change its direction of movement (e.g., change from moving right to moving left). Torque mass 208 may reach a second end (e.g., the right end) of torque axis 210 at t=5T/8, and may reach a maximum negative speed at t=7T/8. The negative force applied to torque mass 208 may exert on object 200 a corresponding positive force of the same magnitude, thus causing object 200 to rotate in the positive direction (e.g., clockwise by angular displacement θ_{F}). Angular displacement θ_{F} is smaller than angular displacement θ_{F} (e.g., due to I_{B}>I_{A}), resulting in a net negative (e.g., counterclockwise) rotation of object 200 having magnitude |θ_{E}|−|θ_{F}|.

The transition of inertial mass 204 from the first end of inertial axis 206 to the second end of inertial axis 206, and vice versa, may be centered around the change in the direction of force applied to torque mass 208. Specifically, inertial mass 204 may move from the first end to the second end of inertial axis 206 from t=T/4 to t=T/2, and may reach a maximum positive speed at t=3T/8 as the direction of the force applied to torque mass 208 changes from positive to negative. Similarly, inertial mass 204 may move from the second end to the first end of inertial axis 206 from t=3T/4 to t=T, and may reach a maximum negative speed at t=7T/8 as the direction of the force applied to torque mass 208 changes from negative to positive. Thus, the positive force may be applied to torque mass 208 while the moment of inertia is below the threshold value of

$${I}_{A} + \frac{{I}_{B} - {I}_{A}}{2}$$

(i.e., the half-way point between I_{A} and I_{B}), while the negative force may be applied to torque mass 208 while the moment of inertia is above the threshold value of

$${I}_{A} + \frac{{I}_{B} - {I}_{A}}{2} .$$

In general, the net rotation θ_{NET} of object 200 may be proportional to n∫₀^{T}F_{T}(t)rp_{I}(t)dt, where n represents the number of periods T in a control operation, F_{T}(t) represents the force applied by torque mass 208 to object 200 over time, r represents a perpendicular component of a distance between torque mass 208 (assumed to be constant in the examples provided herein) and rotational axis 202, and p_{I}(t) represents a position of inertial mass 204 over time (which controls the moment of inertia of object 200).

Accordingly, when ∫ₐ^{b}F_{T}(t)p_{I}(t)dt=−∫_{c}^{d}F_{T}(t)p_{I}(t)dt, the intervals a to b and c to d may have no net effect on rotation of object 200. That is when, during a first time period a to b, the integral of the product of the force applied by torque mass 208 to object 200 and the position of inertial mass 204 is equal to a negative of a commensurate integral for a second time period c to d, an angular displacement of object 200 during the first time period a to b may be equal and opposite to an angular displacement of object 200 during the second time period c to d. In the examples of FIG. 4A and 4B, the first time period may be a=T/4 to b=T/2 and the second time period may be c=3T/4 to d=T.

While torque mass 208 may be used primarily to apply torque to object 200, and inertial mass 204 may be used primarily to adjust a moment of inertia of object 200, movement of torque mass 208 may, in some cases, affect the moment of inertia of object 200 and movement of inertial mass 204 may, in some cases apply a torque to object 200. Accordingly, in some implementations, control strategies may be selected that, during an oscillation period T, produce no net rotation due to torque mass 208 affecting the moment of inertia of object 200 and inertial mass 204 applying a torque to object 200. Specifically, the control strategies may be selected such that ∫ₐ^{b}F_{I}(t)p_{T}(t)dt=−∫_{c}^{d}F_{I}(t)p_{T}(t)dt, where F_{I}(t) represents the force applied by inertial mass 204 to object 200 over time, and p_{T}(t) represents a position of torque mass 208 over time.

In other cases, control strategies may be selected that, during an oscillation period T and using the integral criteria described above, produce a first rotation due to torque mass 208 affecting the moment of inertia of object 200 and inertial mass 204 applying a torque to object 200 in the same direction as a second rotation due to inertial mass 204 affecting the moment of inertia of object 200 and torque mass 208 applying the torque to object 200. In further cases, the first rotation and the second rotation may be in different directions, but the second rotation may be greater than the first rotation, thus allowing the net rotation of object 200 to be controlled primarily be inertial mass 204 affecting the moment of inertia of object 200 and torque mass 208 applying the torque to object 200.

### IV. Alternative Example Arrangements of Oscillating Masses

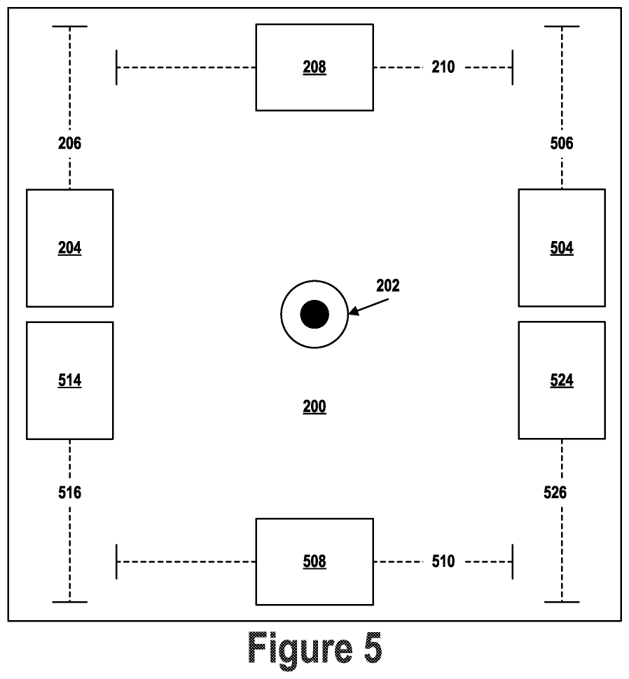

FIG. 5 illustrates another example arrangement of masses that may be used to control the attitude of object 200. Specifically, object 200 may be equipped with inertial masses 204, 514, 504, and 524, and torque masses 208 and 508. Inertial masses 204, 514, 504, and 524 may be configured to move along inertial axes 206, 516, 506, and 526, respectively. Torque masses 208 and 508 may be configured to move along torque axes 210 and 510, respectively. In some cases, inertial axes 206 and 516 may be coincident, and thus treated as a single inertial axis, with each of masses 204 and 514 moving along a corresponding portion (e.g., half) of this single inertial axis. Similarly, inertial axes 506 and 526 may be coincident, and thus treated as a single inertial axis.

Inertial masses 204 and 514 may form a first differential pair that may be configured to apply to object 200 forces that are equal in magnitude but opposite in direction. For example, a mass of inertial mass 204 may be equal to a mass of inertial mass 514. When inertial mass 204 accelerate upwards along inertial axis 206 due to a given force being applied thereto, inertial mass 514 may be configured to accelerate downwards along inertial axis 516 due to an equal and opposite force being applied thereto, and vice versa. Similarly, inertial masses 504 and 524 may form a second differential pair that may be configured to apply to object 200 forces that are equal in magnitude but opposite in direction. Thus, inertial masses 204, 514, 504, and 524 may operate purely to modify a moment of inertia of object 200, but might not apply a torque relative to rotational axis 202. Accordingly, whereas movements of inertial mass 204 involved in adjustments of the moment of inertia may cause object 200 to undergo multiple intermediate rotations that cancel out, synchronized movements of inertial masses 204, 524, 504, and 524 might allow such intermediate rotations to be avoided. That is, balanced motion of the first and second differential pairs may reduce and/or eliminate unwanted vibrations of object 200 caused by movement of the inertial masses.

Torque masses 208 and 508 may form a third differential pair that may be configured to apply to object 200 forces that are equal in magnitude but opposite in direction. For example, a mass of torque mass 208 may be equal to a mass of torque mass 508. When torque mass 208 accelerated leftwards along torque axis 210 due to a given force being applied thereto, torque mass 508 may be configured to accelerate rightwards along torque axis 510 due to an equal and opposite force being applied thereto, and vice versa. Thus, when combined with inertial masses 204, 514, 504, and 524, torque masses 208 and 508 may operate purely to apply a torque to object 200. Notably, although torque masses 208 and 508 may affect the moment of inertia of object 200, inertial masses 204, 514, 504, and 524 might not apply a net torque to object 200, resulting in any change in the moment of inertia due to torque masses 208 and 508 being inconsequential.

In some implementations, one or more of masses 204, 504, 514, 524, 208, and/or 508 may be additionally configured to rotate about their corresponding motion axes, and thus operate as reaction wheels. In one example, inertial mass 204 may change its angular momentum by changing its rotational velocity about inertial axis 206, which may in turn cause an equal and opposite change in angular momentum of object 200 about inertial axis 206. In another example, torque mass 208 may change its angular momentum by changing its rotational velocity about torque axis 210, which may in turn cause an equal and opposite change in angular momentum of object 200 about torque axis 210. Similarly, the angular velocities of other masses on object 200 may be adjusted to control the attitude thereof.

Rotation of masses 204 and 208 (and any of the other masses on object 200) about their respective motion axes may be caused by the respective actuators thereof. For example, mass 204 may be configured to exhibit permanent and/or induced magnetism, thereby having a magnetic field with which another magnetic field generated by the actuator may interact. The actuator may generate the magnetic field using, for example, one or more coils distributed around the corresponding channel, tunnel, and/or conduit within which mass 204 moves. The magnetic field that control the linear motion of inertial mass 204 along inertial axis 206 may be transverse to the magnetic field that controls the rotation of inertial mass 204 along inertial axis 206, thus allowing for independent control of translation and rotation.

In some implementations, one or more of the magnets that make up the actuators of masses 204 and/or 208 (and nay other masses on object 200) may be used as a magnetorquer. Specifically, the magnet may be driven with a non-alternating signal configured to generate a non-alternating magnetic field and/or an alternating signal configured to generate an alternating magnetic field. The non-alternating magnetic field may be configured to interact with an external magnetic field, such as that produced by the Earth, thereby attracting or repelling the magnetorquer and inducing rotation of object 200 about a corresponding axis. The alternating magnetic field may be configured to move the corresponding mass, as discussed above, to control the moment of inertia of object 200 and/or the torque applied thereto.

The masses mounted to object 200 may additionally or alternatively be used to reduce and/or eliminate vibrations of object 200 caused by other components thereof and/or external forces applied thereto. Specifically, object 200 may include mounted thereon one or more sensors (e.g., inertial measurement units) configured to detect vibrations of object 200 along one or more directions. Control circuitry of one or more of the masses mounted to object 200 may be configured to control the one or more masses to counteract the detected vibrations. For example, when a sinusoidal vibration is detected along axis 206, the control circuitry may drive inertial mass 204 with an inverted version of this sinusoidal vibration, which may result in a reduction and/or elimination of the vibration.

In some implementations, inertial mass 204 may be used for vibration reduction and/or elimination when, for example, the amplitude of the detected vibrations exceeds a threshold amplitude value and/or the actuator of mass 204 is configured to drive mass 204 at a frequency of the vibration. In some cases, a signal intended to neutralize a vibration of object 200 may be added to a signal intended to adjust a moment of inertia of object 200 and/or apply a torque thereto. Thus, when a mass is driven with this combined signal, its motion may simultaneously neutralize vibrations and perform a moment of inertia adjustment and/or a torque application.

### V. Example Operations

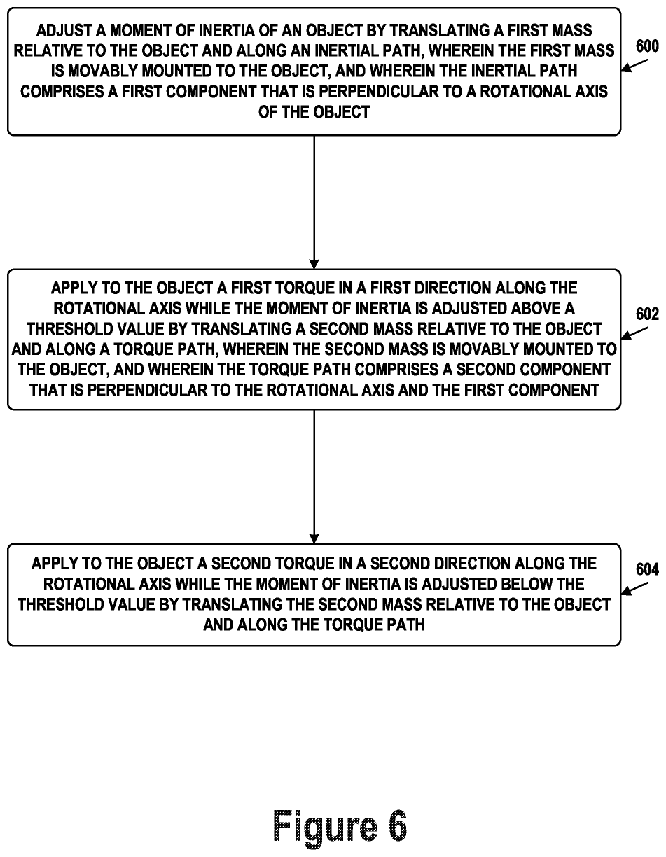

FIG. 6 is a flow chart illustrating an example embodiment. The process illustrated by FIG. 6 may be carried out by inertial mass 204, torque mass 208, one or more actuators thereof, and/or control circuitry. However, the process can be carried out by and/or with the assistance of other types of devices or device subsystems, such as a computing device or programmable controller configured to control movement of masses 204 and 208 using the actuators thereof. The embodiments of FIG. 6 may be simplified by the removal of any one or more of the features shown therein. Further, these embodiments may be combined with features, aspects, and/or implementations of any of the previous figures or otherwise described herein.

Block 600 may involve adjusting a moment of inertia of an object by translating a first mass relative to the object and along an inertial path. The first mass may be movably mounted to the object. The inertial path may include a first component that is perpendicular to a rotational axis of the object.

Block 602 may involve applying to the object a first torque in a first direction along the rotational axis while the moment of inertia is adjusted above a threshold value by translating a second mass relative to the object and along a torque path. The second mass may be movably mounted to the object. The torque path may include a second component that is perpendicular to the rotational axis and the first component.

Block 604 may involve applying to the object a second torque in a second direction along the rotational axis while the moment of inertia is adjusted below the threshold value by translating the second mass relative to the object and along the torque path.

In some embodiments, application of the first torque in the first direction along the rotational axis while the moment of inertia is adjusted above the threshold value may cause a first angular displacement that is smaller than a second angular displacement caused by application of the second torque in the second direction along the rotational axis while the moment of inertia is adjusted below the threshold value such that the object is caused to rotate in the second direction about the rotational axis.

In some embodiments, the inertial path may include an inertial axis that may be substantially perpendicular to the rotational axis, and the torque path may include a torque axis that may be substantially perpendicular to the rotational axis and the inertial axis.

In some embodiments, at least one of the inertial path or the torque path may include an arc that is substantially centered on the rotational axis.

In some embodiments, a first actuator may be configured to cause the first mass to move along the inertial path. The first mass may be movably mounted to the object by way of the first actuator. A second actuator may be configured to move the second mass along the torque path. The second mass may be movably mounted to the object by way of the second actuator.

In some embodiments, at least one of the first actuator or the second actuator may be configured to cause a corresponding mass to move along a corresponding path by generating an electric field configured to exert a force on the corresponding mass by interacting with an electrostatic charge held by the corresponding mass.

In some embodiments, at least one of the first actuator or the second actuator may be configured to cause a corresponding mass to move along a corresponding path by generating a first magnetic field configured to exert a force on the corresponding mass by interacting with a second magnetic field of the corresponding mass.

In some embodiments, the at least one of the first actuator or the second actuator may include a solenoid, and the corresponding mass may be configured to move inside the solenoid.

In some embodiments, the at least one of the first actuator or the second actuator may be additionally configured to operate as a magnetorquer configured to cause the object to rotate by generating a non-alternating magnetic field configured to interact with an external magnetic field.

In some embodiments, the first mass may be configured to adjust the moment of inertia between (i) a maximum value by moving to a first position along the inertial path and (ii) a minimum value by moving to a second position along the inertial path. The threshold value may be between the minimum value and the maximum value. The second position may be closer to a center of mass of the object than the first position.

In some embodiments, the second actuator may be caused to move the second mass at a first constant velocity having a third direction along the torque path. While the second mass moves at the first constant velocity, the first actuator may be caused to move the first mass to the first position. While the first mass is at the first position, the second actuator may be caused to apply to the second mass a first force having a fourth direction along the torque path that is opposite to the third direction along the torque path and thereby apply the first torque in the first direction along the rotational axis. The second actuator may be caused to move the second mass at a second constant velocity having the fourth direction along the torque path. While the second mass moves at the second constant velocity, the first actuator may be caused to move the first mass to the second position. While the first mass is at the second position, the second actuator may be caused to apply to the second mass a second force having the third direction along the torque path and thereby apply the second torque in the second direction along the rotational axis.

In some embodiments, the second actuator may be caused to change a direction of a force applied to the second mass from a third direction along the torque path to a fourth direction along the torque path that is opposite to the third direction. While the direction of the force applied to the second mass changes from the third direction to the fourth direction, the first actuator may be caused to move the first mass to the first position. While the first mass is at the first position, the second actuator may be caused to apply to the second mass a first force having the fourth direction along the torque path and thereby apply the first torque in the first direction along the rotational axis. The second actuator may be caused to change the direction of the force applied to the second mass from the fourth direction to the third direction. While the direction of the force applied to the second mass changes from the fourth direction to the third direction, the first actuator may be caused to move the first mass to the second position. While the first mass is at the second position, the second actuator may be caused to apply to the second mass a second force having the third direction along the torque path and thereby apply the second torque in the second direction along the rotational axis.

In some embodiments, a third mass may be movably mounted on the object and configured to adjust the moment of inertia by translating relative to the object along the inertial path. When the first mass moves in a third direction along the inertial path, the third mass may be configured to move in a fourth direction along the inertial path that is opposite to the third direction. When the first mass moves in the fourth direction along the inertial path, the third mass may be configured to move in the third direction along the inertial path.

In some embodiments, movement of the first mass may be configured to exert on the object a first force that is substantially equal and opposite to a second force exerted on the object by movement of the third mass.

In some embodiments, a fourth mass may be movably mounted on the object and configured to: (i) apply to the object a third torque in the first direction along the rotational axis while the moment of inertia is adjusted above the threshold value and (ii) apply to the object a fourth torque in the second direction along the rotational axis while the moment of inertia is adjusted below the threshold value, by translating relative to the object along a second torque path having a third component that is perpendicular to the rotational axis and the first component and parallel to the torque path.

In some embodiments, the torque path and the second torque path may be substantially parallel. When the second mass moves in a third direction along the torque path, the fourth mass may be configured to move in a fourth direction along the second torque path that is opposite to the third direction. When the second mass moves in the fourth direction along the torque path, the fourth mass may be configured to move in the third direction along the second torque path.

In some embodiments, the first mass may be configured to rotate about a first axis associated with the inertial path, and an angular velocity of the first mass may be adjustable to control an angular position of the object with respect to the first axis. The second mass may be configured to rotate about a second axis associated with the torque path, and an angular velocity of the second mass may be adjustable to control the angular position of the object with respect to the second axis.

In some embodiments, a sensor may be configured to detect a vibration of the object along at least one axis. Sensor data may be received from the sensor. Based on the sensor data, it may be determined that an amplitude of the vibration of the object along the at least one axis exceeds a threshold value. Based on determining that the amplitude of the vibration exceeds the threshold value, an oscillation pattern may be determined for at least one of the first mass along the inertial path or the second mass along the torque path. The oscillation pattern may be configured to generate a counter-vibration configured to counteract the vibration of the object. An oscillation of the at least one of the first mass or the second mass may be controlled by driving the at least one of the first mass or the second mass according to the oscillation pattern.

In some embodiments, the object may include a spacecraft configured to operate in substantially gravity-free space or an aircraft.

### VI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
an object comprising a rotational axis;
a first mass movably mounted to the object and configured to adjust a moment of inertia of the object by translating relative to the object along an inertial path having a first component that is perpendicular to the rotational axis; and
a second mass movably mounted to the object and configured to: (i) apply to the object a first torque in a first direction along the rotational axis while the moment of inertia is adjusted above a threshold value and (ii) apply to the object a second torque in a second direction along the rotational axis while the moment of inertia is adjusted below the threshold value, by translating relative to the object along a torque path having a second component that is perpendicular to the rotational axis and the first component.

2. The system of claim 1, wherein application of the first torque in the first direction along the rotational axis while the moment of inertia is adjusted above the threshold value causes a first angular displacement that is smaller than a second angular displacement caused by application of the second torque in the second direction along the rotational axis while the moment of inertia is adjusted below the threshold value such that the object is caused to rotate in the second direction about the rotational axis.

3. The system of claim 1, wherein the inertial path comprises an inertial axis that is substantially perpendicular to the rotational axis, and wherein the torque path comprises a torque axis that is substantially perpendicular to the rotational axis and the inertial axis.

4. The system of claim 1, wherein at least one of the inertial path or the torque path comprises an arc that is substantially centered on the rotational axis.

5. The system of claim 1, further comprising:
a first actuator configured to cause the first mass to move along the inertial path, wherein the first mass is movably mounted to the object by way of the first actuator; and
a second actuator configured to move the second mass along the torque path, wherein the second mass is movably mounted to the object by way of the second actuator.

6. The system of claim 5, wherein at least one of the first actuator or the second actuator is configured to cause a corresponding mass to move along a corresponding path by generating an electric field configured to exert a force on the corresponding mass by interacting with an electrostatic charge held by the corresponding mass.

7. The system of claim 5, wherein at least one of the first actuator or the second actuator is configured to cause a corresponding mass to move along a corresponding path by generating a first magnetic field configured to exert a force on the corresponding mass by interacting with a second magnetic field of the corresponding mass.

8. The system of claim 7, wherein the at least one of the first actuator or the second actuator comprises a solenoid, and wherein the corresponding mass is configured to move inside the solenoid.

9. The system of claim 7, wherein the at least one of the first actuator or the second actuator is additionally configured to operate as a magnetorquer configured to cause the object to rotate by generating a non-alternating magnetic field configured to interact with an external magnetic field.

10. The system of claim 5, wherein the first mass is configured to adjust the moment of inertia between (i) a maximum value by moving to a first position along the inertial path and (ii) a minimum value by moving to a second position along the inertial path, wherein the threshold value is between the minimum value and the maximum value, and wherein the second position is closer to a center of mass of the object than the first position.

11. The system of claim 10, further comprising:
circuitry configured to perform operations comprising:
causing the second actuator to move the second mass at a first constant velocity having a third direction along the torque path;
while the second mass moves at the first constant velocity, causing the first actuator to move the first mass to the first position;
while the first mass is at the first position, causing the second actuator to apply to the second mass a first force having a fourth direction along the torque path that is opposite to the third direction along the torque path and thereby apply the first torque in the first direction along the rotational axis;
causing the second actuator to move the second mass at a second constant velocity having the fourth direction along the torque path;
while the second mass moves at the second constant velocity, causing the first actuator to move the first mass to the second position; and
while the first mass is at the second position, causing the second actuator to apply to the second mass a second force having the third direction along the torque path and thereby apply the second torque in the second direction along the rotational axis.

12. The system of claim 10, further comprising:
circuitry configured to perform operations comprising:
causing the second actuator to change a direction of a force applied to the second mass from a third direction along the torque path to a fourth direction along the torque path that is opposite to the third direction;
while the direction of the force applied to the second mass changes from the third direction to the fourth direction, causing the first actuator to move the first mass to the first position;
while the first mass is at the first position, causing the second actuator to apply to the second mass a first force having the fourth direction along the torque path and thereby apply the first torque in the first direction along the rotational axis;
causing the second actuator to change the direction of the force applied to the second mass from the fourth direction to the third direction;
while the direction of the force applied to the second mass changes from the fourth direction to the third direction, causing the first actuator to move the first mass to the second position; and
while the first mass is at the second position, causing the second actuator to apply to the second mass a second force having the third direction along the torque path and thereby apply the second torque in the second direction along the rotational axis.

13. The system of claim 1, further comprising:
a third mass movably mounted on the object and configured to adjust the moment of inertia by translating relative to the object along the inertial path, wherein, when the first mass moves in a third direction along the inertial path, the third mass is configured to move in a fourth direction along the inertial path that is opposite to the third direction, wherein, when the first mass moves in the fourth direction along the inertial path, the third mass is configured to move in the third direction along the inertial path, and wherein movement of the first mass is configured to exert on the object a first force that is substantially equal and opposite to a second force exerted on the object by movement of the third mass.

14. The system of claim 1, further comprising:
a fourth mass movably mounted on the object and configured to: (i) apply to the object a third torque in the first direction along the rotational axis while the moment of inertia is adjusted above the threshold value and (ii) apply to the object a fourth torque in the second direction along the rotational axis while the moment of inertia is adjusted below the threshold value, by translating relative to the object along a second torque path having a third component that is perpendicular to the rotational axis and the first component and parallel to the torque path.

15. The system of claim 14, wherein the torque path and the second torque path are substantially parallel, wherein, when the second mass moves in a third direction along the torque path, the fourth mass is configured to move in a fourth direction along the second torque path that is opposite to the third direction, and wherein, when the second mass moves in the fourth direction along the torque path, the fourth mass is configured to move in the third direction along the second torque path.

16. The system of claim 1, wherein the first mass is configured to rotate about a first axis associated with the inertial path, wherein an angular velocity of the first mass is adjustable to control an angular position of the object with respect to the first axis, wherein the second mass is configured to rotate about a second axis associated with the torque path, and wherein an angular velocity of the second mass is adjustable to control the angular position of the object with respect to the second axis.

17. The system of claim 1, further comprising:
a sensor configured to detect a vibration of the object along at least one axis; and
control circuitry configured to perform operations comprising:
receiving sensor data from the sensor;
determining, based on the sensor data, that an amplitude of the vibration of the object along the at least one axis exceeds a threshold amplitude value;
based on determining that the amplitude of the vibration exceeds the threshold value, determining an oscillation pattern for at least one of the first mass along the inertial path or the second mass along the torque path, wherein the oscillation pattern is configured to generate a counter-vibration configured to counteract the vibration of the object; and
controlling an oscillation of the at least one of the first mass or the second mass by driving the at least one of the first mass or the second mass according to the oscillation pattern.

18. The system of claim 1, wherein the object comprises a spacecraft configured to operate in substantially gravity-free space or an aircraft.

19. A method comprising:
adjusting a moment of inertia of an object by translating a first mass relative to the object and along an inertial path, wherein the first mass is movably mounted to the object, and wherein the inertial path comprises a first component that is perpendicular to a rotational axis of the object;
applying to the object a first torque in a first direction along the rotational axis while the moment of inertia is adjusted above a threshold value by translating a second mass relative to the object and along a torque path, wherein the second mass is movably mounted to the object, and wherein the torque path comprises a second component that is perpendicular to the rotational axis and the first component; and
applying to the object a second torque in a second direction along the rotational axis while the moment of inertia is adjusted below the threshold value by translating the second mass relative to the object and along the torque path.

20. A non-transitory computer-readable medium having stored thereon program instructions that, upon execution by a computing system, cause the computing system to perform operations comprising:
adjusting a moment of inertia of an object by causing a first mass to translate relative to the object and along an inertial path, wherein the first mass is movably mounted to the object, and wherein the inertial path comprises a first component that is perpendicular to a rotational axis of the object;
applying to the object a first torque in a first direction along the rotational axis while the moment of inertia is adjusted above a threshold value by causing a second mass to translate relative to the object and along a torque path, wherein the second mass is movably mounted to the object, and wherein the torque path comprises a second component that is perpendicular to the rotational axis and the first component; and
applying to the object a second torque in a second direction along the rotational axis while the moment of inertia is adjusted below the threshold value by causing the second mass to translate relative to the object and along the torque path.
